(19) United States
(12) Patent Application Publication
(10) Pub. No.: US 2018/0366867 A1
(43) Pub. Date: Dec. 20, 2018

(54) WEATHER-PROOFING SOLUTION FOR A CABLE CONNECTION

(71) Applicant: 3M INNOVATIVE PROPERTIES COMPANY, St. Paul, MN (US)

(72) Inventors: Karl E. Wolf, Round Rock, TX (US); Zhiyong Xu, Shanghai (CN); Donald K. Larson, Cedar Park, TX (US); Joseph C. Carls, Austin, TX (US); Daniel J. Treadwell, Austin, TX (US)

(21) Appl. No.: 15/571,370

(22) PCT Filed: May 12, 2016
(86) PCT No.: PCT/US16/31968

§ 371 Date: Nov. 2, 2017

(30) Foreign Application Priority Data
May 15, 2015 (CN) PCT/CN2015/079036

(51) Int. Cl. H01R 13/52; H02G 15/196

(52) U.S. Cl. CPC H01R 13/5221; B32B 25/08; H02G 15/196

(57) ABSTRACT

The present invention is directed to a weather-proofing solution for protecting a cable that includes a new weather proofing sheet, a new applicator tool and a new method of installing the weather proofing material over a cable connection to provide environmental protection to the cable connection. The weather-proofing material is a preformed sheet having a body portion and two spaced apart tail portions extending longitudinally from one end of the body portion wherein the preformed sheet has a variable elongation along its length when wrapped around the cable connection under a constant force.

### FIELD OF THE INVENTION

The present invention relates to simple weather proofing solutions to protect a connection between two cables, the connection between a cable and a housing or a defect or break in a cable jacket. In particular, a new weather proofing material, a new applicator tool and a new method of installing the weather proofing material over a cable connection to provide environmental protection to the cable connection is described.

### BACKGROUND

In the telecommunication, electric or electronic industries, electrical connectors have been widely used to connect coaxial cables to equipment and other cables. The electrical connectors are generally made from plated brass and the cables generally have an external polyvinylchloride (PVC) or polyethylene (PE) layer. For example, on cell phone towers, thick coaxial cables run between the radio antennas high on the tower to a hut on the ground containing electronics. On each end of the cables are electrical connectors. The connectors on the tower are susceptible to the environment and must be protected from moisture and potential corrosion. Cell phone operators have chosen to weather proof these connectors to increase the reliability of the system and to prevent electrical degradation caused by water and other contaminants or weather factors.

In order to solve the above problem, a sealing technology in which a shrink tube having a pressure sensitive adhesive, mastic or water excluding gel material inside is installed onto a surface of the electrical connector has been developed. However, this sealing technology is disadvantageous in that the pressure sensitive adhesive, mastic or water excluding gel material has insufficient strength and is easily aged, it may be difficult to install the shrink tube onto a surface of the electrical connector, and it may be also difficult to remove the shrink tube for periodic inspection or maintenance without destroying the shrink tube. In addition, the cable connection must be separated or opened, cutting service to the customer, in order to install a shrink tube on the cable prior to sliding it over the cable connection. Another conventional sealing technology involves installing a sealing box having silicone gel inside onto a surface of the electrical connector. However, this sealing technology has disadvantages of easy water penetration and difficult installation and inspection or maintenance.

One conventional low cost sealing technology involves wrapping multiple alternating layers of different tape-like products over the cable connection. However, though inexpensive, this technology is time-consuming and cumbersome to do especially when protecting closely spaced connectors or when doing an aerial or tower installation, and the effectiveness is dependent on the skill of a technician. Additionally, the difficulty in installing these materials at a high level or at the top of tower, ultimately affects the safety of the technician. Telecommunication cables are ubiquitous and used for distributing all manner of data across vast networks. As telecommunication cables are routed across data networks, it is necessary to periodically connect and disconnect the cable to other cables or equipment.

A relatively costly method of weatherproofing a cable connection requires placing a rigid enclosure that incorporates a sealing material around the cable connection. Typical enclosures for the telecommunications market provide mechanical and/or environmental protection for cable connections. The rigid shell provides protection against mechanical impact and the sealing material prevents the entry of moisture, dirt, salt, acid rain, or other environmental contaminants. Many different types of enclosures providing different levels of protection for cable splices are commercially available, including so-called re-enterable enclosures that can be re-opened to permit access to the splice whenever required. These conventional telecommunication enclosures are often employed to protect a plurality of twisted pair copper splices and/or fiber optic connections in the outside plant telecommunications market. These closures can be relatively large and bulky, and may not be well suited to applications requiring a single closure to protect a single connection point between two or more communication cables, between a cable and a housing (e.g. a cabinet, a bulkhead, a larger enclosure or housing for a piece of equipment) or between a cable and a piece of equipment, especially when the cable connections are densely placed or ganged connections such as one might find in cell tower installations. Due to the tolerance needed to ensure sealing, rigid enclosures may be designed to protect specific types/sizes of connectors. It can be challenging to design a rigid enclosure to protect a wide range of connector types and sizes.

Thus, a need exists for a simple, low cost weather proofing solution that can be applied in tight spaces and which has improved workability in the field.

### SUMMARY

The present invention is a weather-proofing solution for protecting a cable connection that solves or alleviates one or more of the problems of the prior art.

In a first embodiment, a weather-proofing solution for protecting a cable connection is described. The weather-proofing solution is a preformed sheet of weather proofing material wherein the preformed sheet comprises a body portion and two spaced apart tail portions extending longitudinally from one end of the body portion. The preformed sheet has a variable elongation along its length when wrapped around the cable connection under a substantially constant application force. An inside edge of each of the tail portions flares away from a centerline of the preformed sheet by an angle, θ, in a range of 0°<θ<30°, allowing the tail portions to spread away from the centerline when wrapped and initiating a helical wrapping pattern as the tail portions are wrapped around the ends of the cable connection.

In a second embodiment, an applicator tool for applying weatherproofing material to a cable connection is described. The applicator tool includes a brake roller that is supported in an applicator housing. A preformed sheet of weather proofing material can be wrapped around a portion of the brake roller such that the brake roller is in substantially non-slipping mechanical contact with the weatherproofing material and wherein the brake roller rotates at a circumferential speed, such that the magnitude of the circumferential speed of the brake roller is less than the magnitude of an application speed resulting in controlled elongation and tensioning of the weatherproofing material.

In a third embodiment a method of applying a sheet of weather-proofing material to a cable connection is described. An applicator tool is provided that includes a brake roller supported in a first compartment of an applicator housing, and a preformed sheet of weatherproofing material wrapped around a portion of the brake roller. A cable connection is placed in a second compartment of the applicator tool. A first end of the weatherproofing material is secured to a central portion of the cable connection and the applicator tool rotated or wound around the cable connection with a constant application force such that a central portion of the cable connection is cylindrically wrapped by a first portion the weatherproofing material and a region on either side of the central portion is helically wrapped by a second portion the weatherproofing material.

In a fourth embodiment, a method of applying a preformed sheet of weather-proofing material to a cable connection is described wherein the preformed sheet comprises a body portion and two spaced apart tail portions extending longitudinally from the body portion wherein the preformed sheet has a variable elongation along its length when wrapped around the cable connection under a constant stress. The body portion of the weatherproofing material is wrapped around a central portion the cable connection using a cylindrical wrapping configuration and the tail portions are helically wrapped on either side of the central portion the cable connection.

### BRIEF DESCRIPTION OF THE DRAWINGS

The present invention will be further described with reference to the accompanying drawings wherein like reference numerals refer to like parts in the several views, and wherein:

FIG. 1 is an isometric view of a plurality of bulkhead cable connections.

FIG. 2 is a partial schematic cross section of a connector covered by a spiral wrap of a film or tape.

FIGS. 3A-3E are five views of exemplary weather proofing sheets according to the present invention.

FIGS. 4A-4C are three views showing the installation of the exemplary weather proofing sheet of FIG. 3A over a cable connection.

FIGS. 5A-5E are five views of an exemplary applicator tool that can be used to install a weather proofing sheet around a cable connection according to an embodiment of the present invention.

FIGS. 6A-6D are four views showing the installation of a weather proofing sheet around a cable connection using the exemplary applicator tool of FIGS. 5A-5D.

FIG. 7 shows the elongation profile of an exemplary sheet of weather proofing material when it is applied over a cable connection by the applicator tool of FIGS. 5A-5D under a constant application force.

FIGS. 8A-8F are six views of an alternative embodiment of an exemplary applicator tool that can be used to install a weather proofing sheet around a cable connection according to an embodiment of the present invention.

While the invention is amenable to various modifications and alternative forms, specifics thereof have been shown by way of the drawings and will be described herein in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention relates to an exemplary weather-proofing solution to protect a connection between two or more cables, or between a cable and a bulkhead fitting (i.e. connection between a cable and a housing or piece of equipment). In an exemplary aspect, the exemplary connector can be used to provide environmental protection to cellular antenna bulkhead fittings. The exemplary weather-proofing solution can also be used to repair the sheath of a cable that has been damaged due to wear and abrasion or as can occur when utility crews are digging around or near buried cables. In yet another aspect, the exemplary weather-proofing solution can be used to provide environmental protection at the point where a cable enters duct to prevent contaminants from entering the duct. In an alternative aspect, the exemplary weather-proofing solution can protect the junction between a cable and a ground wire. In an alternative aspect, the exemplary weather-proofing solution can be used to protect a cable connection where two connectors are mated through the use of an adapter or coupling.

Many conventional connectors used in the telecommunication, cable TV, agriculture, and public utilities, even those having internal sealing members (i.e. O-rings), do not provide adequate environmental and/or mechanical protection for the cable connection by themselves. Without additional external protection, water and other contaminants can penetrate the system and degrade the electrical or optical connection. To compensate for this shortcoming in the connectors, system operators will frequently place the cable connection in a molded enclosure, encapsulate, or wrap the cable connection with tapes and/or mastics to provide the necessary environmental and mechanical protection.

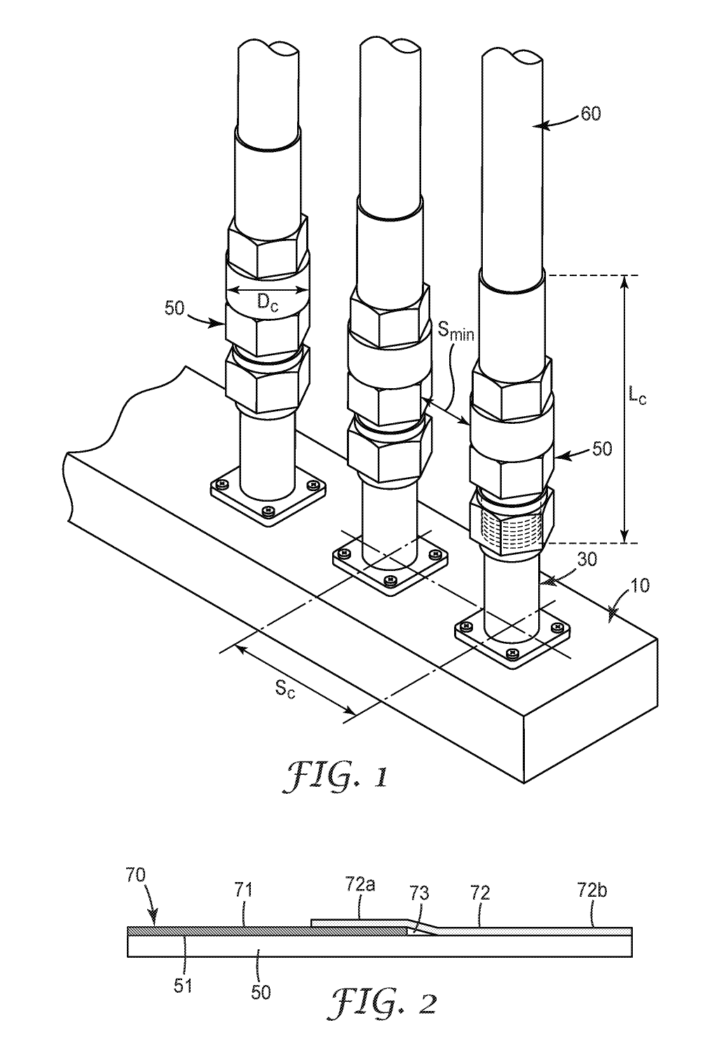

However, in some applications, where it is desirable to individually protect connections in confined spaces, such as in cellular installations, there can be little space between adjacent cable connections to accommodate conventional molded enclosures. In addition, the density of cable connections to cellular equipment is increasingly driving the use of smaller and smaller connectors that are being placed closer and closer together as shown in FIG. 1. The cable connections are made on a bulkhead 10 via a connector 50 disposed on a terminal end of a cable 60 and a receptacle 30 disposed on the bulkhead. Exemplary connectors used in cellular installations include N-type coaxial cable connectors such as part numbers 082-209-1066 and 082-4427 available from Amphenol® RF (Danbury, Conn.) or Part number 172102H243 available from Amphenol® Connex (Moorepark, Calif. and 7/16 coaxial cable connectors, such as part numbers 272105 and 272190 available from Amphenol® Connex (Moorepark, Calif.). Weather proofing solutions are needed that are quick and easy to apply in confined spaces (e.g. where the center to center spacing between adjacent connectors can be between about 35 mm and about 100 mm or wherein the space, Sₘᵢₙ, between adjacent connectors or between a connector and another obstacle is between about 14 mm to about 60 mm.

One conventional low cost weather-proofing method used involves manually wrapping multiple layers of different types of tape and mastic around and over the connector and the adjacent cabling to provide a measure of environmental protection for the cable connection. This helical wrapping process can be a tedious, time consuming operation, and weather proofing effectiveness is highly dependent on the skill of the installer and the conditions under which the tape is applied. Additionally, when the wrap process is employed in aerial installations such as those that occur high up on cellular towers, the difficulty in properly using these materials is amplified and ultimately affects the safety of the technician. Finally, the tape/mastic wrapping must be cut away during routine inspection and maintenance operations and reapplied when these operations are complete, requiring additional time and expense.

FIG. 2 is a partial schematic cross-section of a connector 50 covered by a spiral wrap of a film or tape 70. The first wrap layer 71 can lie such that it is in contact with on the surface 51 of the connector. When the second layer 72 is applied a first portion 72a of the second wrap layer is disposed over the first wrap layer and a second portion 72b of the second wrap layer is disposed against the surface 51 of the connector. In the transition between the first and second portions 71a, 71b of the second wrap layer, a spiral leak path 73 can be created. Similarly, a spiral leak path can be created for each additional wrap layer. The spiral leak path can wrap around a connector or cable wound in this fashion which can provide a capillary pathway for water to infiltrate under the film or tape to the connector when the cable connection is submerged or otherwise subjected to water. The capillary action of the pathway can draw the water between the layers of film to the connector.

The exemplary weather-proofing solution described herein includes a new weather proofing sheet, a new applicator tool and a new method of installing the weather proofing material over a cable connection to provide environmental protection to the cable connection.

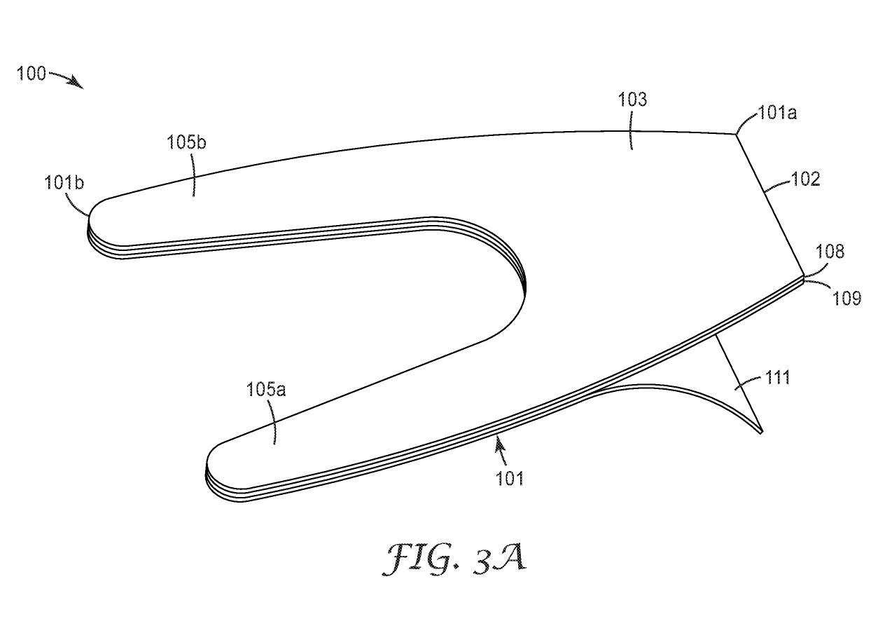

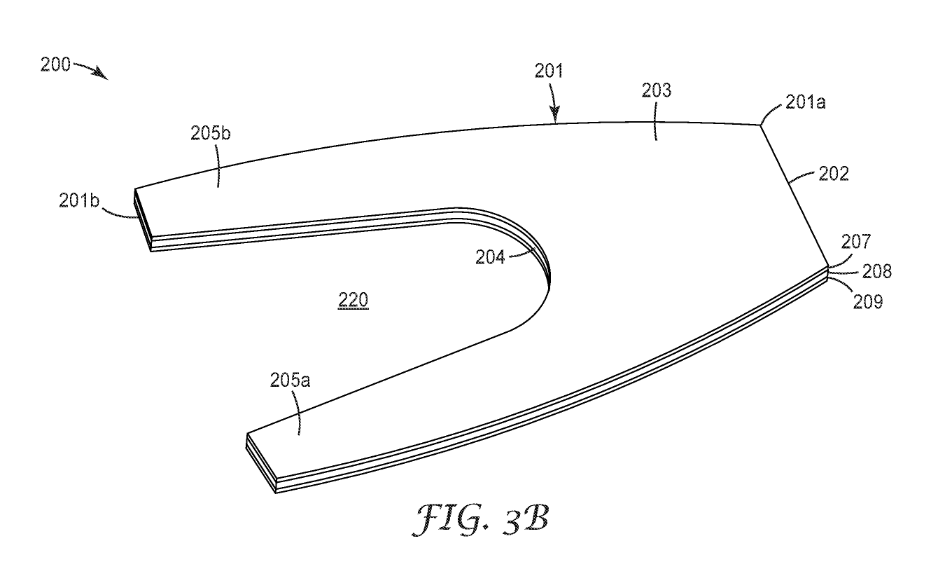

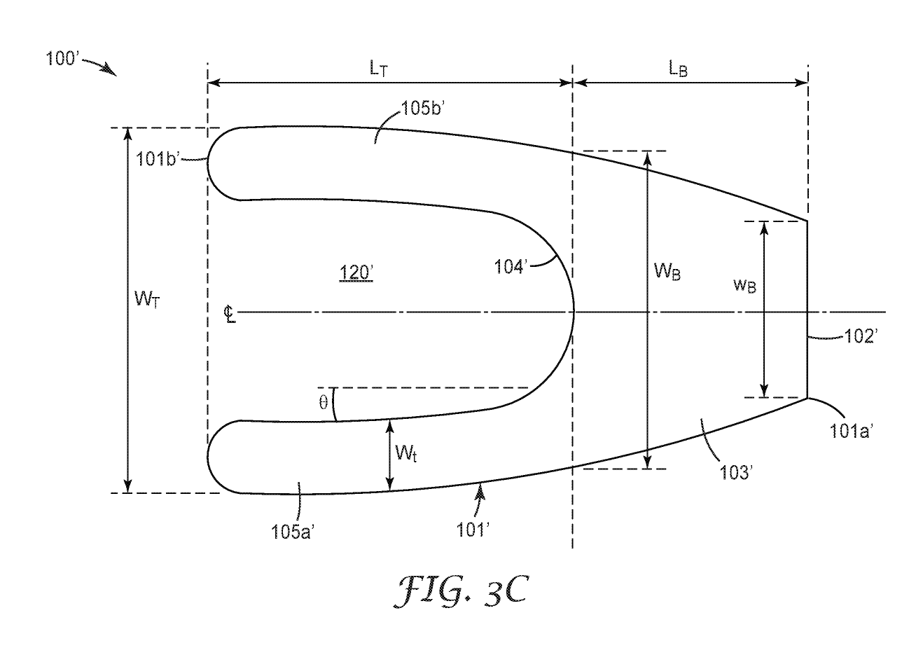

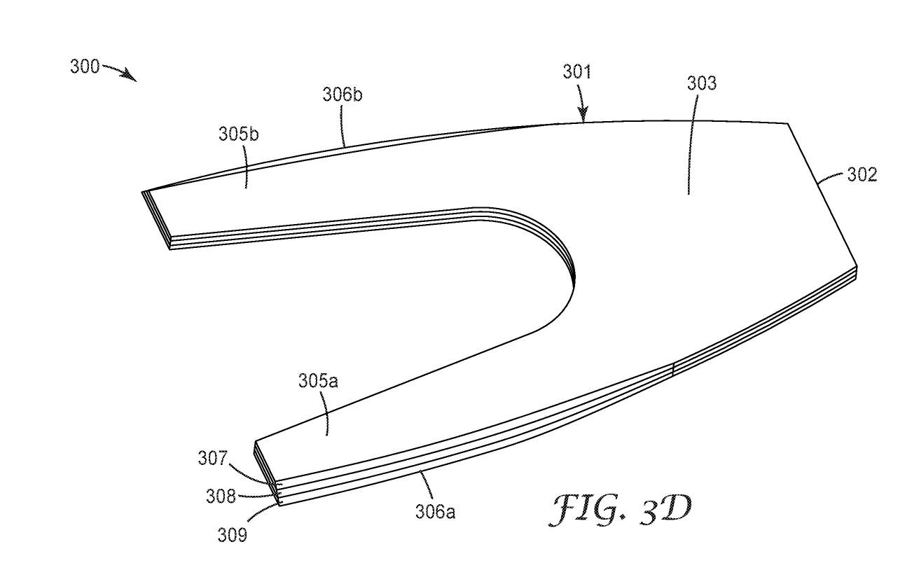

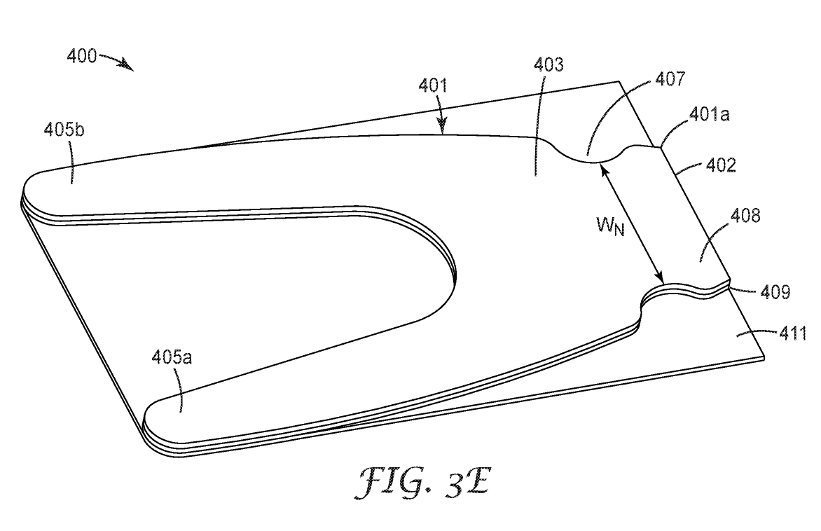

In a first embodiment of the exemplary weather-proofing solution, a weather proofing material 100, shown in FIG. 3A, is a two layer material comprising a first compliant layer 109 disposed on a first major side of a substrate layer 108. The weather proofing material can be preformed into a shaped sheet. The preformed sheet 101 comprises a body portion 103 and two spaced apart tail portions 105a, 105b extending longitudinally from the body portion. The preformed sheet extends longitudinally from a nose portion 102 at the first end of the preformed sheet 101a to the ends of the tail portions denoting the second end 101b of the preformed sheet. FIG. 3A shows preformed sheet 101 having tapered tail portions 105a, 105b having rounded ends. The weather proofing material 100′ shown in FIG. 3C is similar to weather proofing sheet 100 of FIG. 3A except that preformed sheet 101′ includes tail portions 105a′, 105b′ having a substantially constant width, wₜ, and round ends, while FIGS. 3B and 3D show tail portions 205a, 205b and 305a, 305b having blunt ends.

A release liner 111 can be disposed over the compliant layer to protect the compliant layer from premature bonding to other sections of the preformed sheet 101 when rolled, as well as protecting the surface of the compliant layer from contamination from debris or dust. In a first aspect, the release liner can be cut to the same size and shape as that of the preformed sheet as release liner 111 shown in FIG. 3A. Release liner 111 can be applied to the compliant layer of an unformed web of weather proofing material and shaped at the same time the shaped preformed sheet of weatherproofing material is cut from the web via a punching or laser cutting forming process. Alternatively, the preformed sheet of weather proofing material can be disposed on a continuous section of a release loner such as release liner 411 in FIG. 3E. In this aspect, release liner 411 can be applied to the compliant layer 409 of an unformed web of weather proofing material and the preformed sheet 401 can be kiss cut from the web, or the preformed sheet 401 can be cut from the web prior to being applied to release liner 411.

In a preferred aspect, the weatherproofing material is stretched as it is applied over a cable connection to ensure the proper sealing performance. Stretching the weatherproofing material allows it more closely conform to the geometry (i.e. the profile changes) of the cable connection. The more that the weatherproofing material can stretch (e.g. the higher the elongation), the larger profile variations of the cable connection can be accommodated. When a stretched material is applied to the cable connection, the stretched material will conform to the shape of the cable connection allowing for each subsequent wrap to conform to the prior layer and the next geometrical features of the cable connection without creating any gaps or wrinkles. Applying several overlapping wraps that conform to and apply an inward radial compression on the layer below, creates a sealed cover over the cable connection. The stretched material also applies an inward compressive force to the compliant layer that squeezes or pushes the compliant layer material into any gaps, thus sealing any potential leak paths.

In a second embodiment of the exemplary weather-proofing solution, weather proofing material 200, shown in FIG. 3B, is a three layer material comprising a first compliant layer 207 disposed on a first side of a substrate layer 208 and a second compliant 209 disposed on a second side of a substrate layer opposite the first compliant layer. The weather proofing material can be preformed into a shaped sheet. The preformed sheet 201 comprises a body portion 203 and two spaced apart tail portions 205a, 205b extending longitudinally from the body portion. The preformed sheet extends longitudinally from a nose portion 202 at the first end of the preformed sheet 201a to the ends of the tail portions denoting the second end 201b of the preformed sheet. FIG. 3B shows preformed sheet 201 having blunt ended tail portions 205a, 205b while FIG. 3A shows preformed sheet 101 having round ended tail portions. Optionally, a release liner(s) (not shown) can be disposed over either the first and/or second compliant layers to enable transport and/or winding of the preformed sheet of weatherproofing material. In one exemplary aspect, the preformed sheet of weatherproofing can be wound on a core. In an alternative aspect, the preformed sheet of weatherproofing can be formed as a self-supporting roll, while in yet another aspect, the preformed sheet of weatherproofing can be used as a flat sheet of material.

The layers in the weatherproofing sheet can be selected to satisfy different physical/mechanical properties of the weatherproofing sheet. The compliant layers can be chosen for their ability to fill gaps, surface tension hydrophobicity, etc. In some aspects the compliant later may have adhesive properties responsible for holding the waterproofing material in place when wrapped around a cable connection. In an alternative aspect a piece of tape, a cable tie or other mechanical attachment means can be used to hold the waterproofing material in place when wrapped around a cable connection. The substrate layer, when tensioned in the process of applying the weatherproofing sheet, provides a compressive force to the compliant layer(s) which can cause the compliant material to flow into any gaps formed when the weatherproofing sheet is wrapped around a cable connection. In addition, the substrate layer facilitates the handling of an unsupported weatherproofing sheet which aids in installation of the sheet over a cable connection.

Exemplary materials for the substrate layer can include polyvinyl chloride polymer films, olefin based polymer films, urethane polymer films, polyether based polymer films, acrylic based polymer films, etc. Exemplary polymer films should have an elongation at break from about 100% to about 2000% and a tensile strength of between 1 MPa and 100 MPa. The degree of elongation that the weatherproofing material is subjected during use depends on the difference between the maximum and minimum diameters of the cable connection being protected, and the need to for the sheet to apply a sufficient compressive force on the compliant layer to ensure adequate sealing. Thus, when the exemplary weather proofing material is used in a cable sheath repair (i.e. a negligible diameter difference) the weather proofing material may not need to stretch as much as when dealing with a cable connection where there is a substantial diameter difference.

In many installation procedures, especially installation procedures using an applicator tool, it is preferable and convenient to install the weatherproofing sheet under a constant application force. Preferred installation forces range from the minimum force required to create enough compression when wrapping to provide an effective environmental seal when applied to a cable connection, to a maximum force that is determined primarily by the installation method and the structural strength of the connector and its mounting. In particular, in order to create an effective seal using the exemplary weatherproofing sheets, the minimum tensioning force can be in the range of about 0.25 lb/inch to about 2 lb/inch of width of the weatherproofing sheet, depending on the composition of the sheet (e.g. materials composition, thickness, etc.). For some common cable connections (i.e. coaxial connections made on a cellular tower), a typical required width of the weatherproofing sheet can be about 4 inches, so a typical minimum tensioning force would be in the range of 1 lbs. to about 8 lbs. For a hand operated tool with little leverage, the maximum installation force that can be reasonably applied is in the range of 30 lbs. to about 50 lbs. Practically speaking, even with a powered tool or one with leverage, application forces beyond this range might damage the connector or the connector mount and thus should be avoided. Those experienced in the art will recognize that the minimum application force will scale with the width, W_{B}, of the body portion of the sheet of weatherproofing material. In applications where leverage can be applied, higher maximum application forces can be achieved.

The balance between desired application force and required elongation for a specific substrate layer can be achieved by proper choice of the thickness of the substrate layer (i.e. substrate materials with lower tensile strength can be made to sustain the desired tension force by increasing the thickness of the substrate layer). Materials with high tensile strength can be made to sustain the desired elongation by reducing the thickness. The substrate thickness is chosen to maintain the desired tension force, while still allowing the required elongation, without breaking. In practice, the product of the tensile modulus of the substrate material times the cross-sectional area of the weatherproofing pad near the nose area should fall into the range of desired tensioning forces.

In an exemplary aspect the first and/or second compliant layers can be a pressure sensitive adhesive layer, a gel-like layer, a mastic layer, or any material that is soft enough to conform easily to uneven surfaces, as described below. The compliant/layer can be used to hold the weather-proofing material in place over the cable connection and/or to seal gaps or leak paths created when the weather proofing material is wrapped around the cable connection. Thus, the compliant layers should be relatively soft, having a range of hardness from Shore 000 Hardness=1 to Shore A Hardness=35.

Exemplary mastic materials can include butyl rubber mastic materials, silicone based mastic materials, and the like. In one aspect of the invention, a 2-layer preformed sheet of weatherproofing material can be formed from Scotch® Vinyl Mastic Tape 2210 or Scotch® Electrical moisture Sealant 06147 available from 3M Company (St. Paul, Minn.).

Exemplary pressure sensitive materials can be selected from acrylic pressure sensitive adhesives, methacrylic pressure sensitive adhesives, olefin based pressure sensitive adhesives, rubber based pressure sensitive adhesives, silicone based pressure sensitive adhesives, and the like. Exemplary materials for the first and second adhesive layers have a storage modulus at 25° C. and 1 Hz between about 0.1 MPa to about 6.9 MPa.

In general, the greater the thickness of the compliant layer can lead to improved gap filling, conformability and adhesion. This is especially true for compliant materials at the upper end of the range of storage modulus. However, for very soft materials, the maximum useful thickness may be limited by excessive flow of the compliant material.

When the compliant material is a mastic or a pressure sensitive adhesive, the material for the compliant layer in the two layer construction should adhere to the substrate layer, the cable jacket material and the cable connector material, while in the three layer construction the compliant layers should be self-adherent, as well as adhering to the cable jacket material and the cable connector material.

In one aspect, portions of the surface of the compliant layer(s) may be detackified by dusting with glass bubbles, talc or finely dispersed clay dust. For example, the center of the body portion may be detackified while leaving the edges of the body portion and the tail portions tacky, which can aid in removal of the release liner from the preformed sheet during installation around a cable connection.

Some embodiments of the exemplary weatherproofing material may be applied at low temperatures from about −20° C. to about 0° C. Thus, the glass transition temperature of the compliant layers should be less than about −40° C. for low temperature installation of the weatherproofing material around a cable connection.

In some embodiments, the preformed sheet of weatherproofing material can have an overall thickness in the range of about 0.02 mm to about 2.5 mm, preferably from about 0.13 mm to about 0.7 mm. The ratio of the thickness of the compliant layer(s) to the thickness of the substrate layer can be 100:1 to about 1:3.

The weather-proofing material can be prepared using known continuous co-extrusion techniques and then cut into the desired preformed sheet by a conventional die cutting or laser cutting process. For example, multiple polymeric flow streams can be combined in a die or feed block in a layered fashion to provide a continuous multilayer film. Alternatively, the weather-proofing material can be prepared by lamination of pre-formed component layers or by a combination of coating and lamination. For example, weather-proofing material can be prepared by coating a resin, which when dried or cured becomes the first adhesive layer, onto a first major surface of the substrate layer in a first pass, turning the substrate layer over and coating with a second resin material which when cured becomes the second adhesive layer, on the second major surface of the substrate layer on a second pass. For adhesives or resins that require curing, the resin can be cured chemically using known crosslinking agents or for example, by applying actinic radiation (e.g., UV-radiation or electron beam radiation).

Referring to FIGS. 1 and 3C, the body portion 103′ of weatherproofing material 100′ extends from the nose portion 102′ at the first end 101a′ of the preformed sheet 101′ and continually widens from the nose portion along the length, L_{B}, of the body portion. The length of the body portion can be greater than the nominal circumference of connector 50 (i.e. L_{B}>πD_{C}). In embodiments where the weather proof material has sufficient elongation, the length of the body portion can be between 90% of the nominal circumference to about 300% of the nominal circumference or 0.9 πD_{C}<L_{B}<3πD_{C}. The maximum width of the body portion, W_{B}, can be selected to be about the same as the length of the connector to be protected, L_{C}. The width of the nose portion (i.e. the minimum width of the body portion) can be designated by W_{B} as shown in FIG. 3C. The ratio of w_{B}/W_{B} can be in the range of about 0.35 to about 0.75, preferably about 0.45 to about 0.55. Having the nose portion narrower than the remaining body portion helps ensure the sealing performance of the weatherproofing material when it is wrapped around the cable connection (i.e. connector 50 and receptacle 30).

Tail portions 105a′, 105b′ extend from body portion 103′ on the side opposite nose portion 102′, such that there is a cut-out portion 120′ between the tail portions. The cutout portion between the tail portions allows the tail portions to spread away from the center line of the sheet of weatherproofing material as they are wrapped around the cable connection facilitating the helical wrap pattern of the tail portions.

Each tail portion 105a′, 105b′ has two generally parallel longitudinal edges along a substantial portion of the tail portion, such that the tail portions have a constant width, Wₜ, over a substantial portion of their length, L_{T}. The length of the tail portions can be from about two to about 5 times the nominal circumference of the connector to be protected. In an alternative aspect, the tail portions can be tapered being wider near body portion 103′ and narrower near the free ends of the tail portions. Decreasing the width of the tail portions may increase the elongation of the tail portions under a constant force. The inside edge of each tail portion flares away from the centerline, ℄, of the preformed sheet near the point where they extend from the base portion in the form of a semicircular arc 104′ at the top of the cut-out portion while the tail portions can flare away from the centerline by an angle, θ, which allows the wrapping of the tail portions to spread away from the centerline of the preformed sheet and initiates a helical wrapping pattern as the tail portions are wrapped around the ends of the cable connection. In an exemplary aspect, 0°<θ<30°, preferably 5°<θ<15°. Curving the junction between the two tail portions prevents stress concentration points during installation of the weather-proofing onto the cable connection.

The total width, W_{T}, of the preformed sheet 101′ of weatherproofing material 100′ is determined by the length and spread of the tail portions and can be between about 1.2 to about 2 times the connector length, L_{C}.

To successfully seal a cable connection using a single wrap layer, the gap caused by the overlay of tape layers must be eliminated. In a first embodiment the compliant layer can flow into the gap to provide the necessary level of environmental performance.

In an alternative embodiment, at least a portion of the edges of the preformed sheet can be beveled to minimize the size of the gap that is created when a sealing material is helically wrapped around the cable connection. For example, FIG. 3D shows a preformed sheet 301 of weather proofing material 300 that has a three layer structure having a first compliant layer 307 disposed on a first side of a substrate layer 308 and a second compliant 309 disposed on a second side of a substrate layer opposite the first compliant layer. The preformed sheet includes a body portion 303 and two spaced apart tail portions 305a, 305b extending longitudinally from the body portion. A portion of outside edge 306a, b of the tail portions is beveled which will aid in minimizing any potential gaps formed during the helical wrapping of the tail portions. The angle of the bevel can be between 20° and about 60° depending on the construction of the weatherproofing material, preferably about 45°. Beveling at least a portion of the edge of the preformed sheet may allow the use of thinner compliant layers since any gaps formed will be smaller and will not require as much material to ensure adequate sealing performance and thus enabling a thinner overall construction for the weatherproofing sheet. In some embodiments the entire edge of the preformed sheet of weatherproofing material may be beveled.

FIG. 3E shows another alternative embodiment of a preformed sheet 401 of weatherproofing material 400. Preformed sheet 401 has a two layer construction comprising a first compliant layer 409 disposed on a first major side of a substrate layer 408 and a release liner 411 disposed on the open face of the compliant layer. The weather proofing material can be preformed into a shaped sheet. In addition to the nose portion 402 formed at the first end 401a of the sheet and a body portion 403 having two spaced apart tail portions 405a, 405b extending longitudinally from the body portion, preformed sheet 401 has a neck portion 407 disposed between the nose portion and the body portion. The width of the neck portion, W_{N} is less than the width of the nose portion which is less than the width of the body portion. When installed over a cable connection, the nose portion can be adhered to a central portion of the connector. When the application force is applied to the preformed sheet the reduced width of the neck portion means that this portion of the preformed sheet is subjected to a higher stress which allows this section of the sheet to preferentially stretch compared to the nose portion or the wider body portion. This allows the neck portion of the sheet to wrap around the connector over the nose portion and lock the nose portion of the weatherproofing in place prior to over wrapping with the body portion of the preformed sheet. Adding the neck portion to the preformed sheet can allow the use of weatherproofing materials having higher modulus materials for the substrate layers which would normally require the application force which is greater than the adhesion of the nose portion to the connector. In addition, narrower neck portion allows for the use of a wider nose portion which can provide higher initial adhesion to the connector. This reduces the likelihood that the nose portion will separate from the connector during the period from when tension is initially applied until one full wrap is applied to the connector, stabilizing the adhesive bond.

On any of the preceding embodiments, a different adhesive may be applied at the nose portion to provide increased initial tack of the nose portion to the connector body. This is especially useful when the compliant material used for sealing does not have sufficient tack to maintain adhesion to the connector as tension is applied to the preformed sheet.

The unique shape of the preformed sheet of the weathering proofing materials provides for a cylindrical wrapping pattern around the body of connector 50 and a multilayer helical wrap at either end of the cylindrical wrap over the bulkhead receptacle on one side of the cable connection and over the cable jacket on the other side of the cable connection. The variable width of the preformed sheet allows length locations of the preformed sheet to stretch by different amounts along the length of the preformed sheet even when the installation tool applies a constant application force. The wrapping of the preformed sheet around an exemplary cable connection will be described in additional detail below.

The exemplary weatherproofing material can be used to provide environmental protection for cable connections at wireless communication sites, such as to protect the connector used to connect RF coaxial cable to the antennas and equipment disposed on a tower. The connectors on cellular communication towers may be subject to regular maintenance and/or inspection. In order to inspect the cable connection protected by the exemplary weather proofing sheet, the material must be removed from the cable connection and then a new protective sheet applied after the inspection/maintenance is complete. Therefore, an exemplary weather proofing material should remove cleanly from the cable connection leaving a minimal amount of residue on the connector or cable jacket adjacent to the connector reducing or eliminating the need to clean the cable connection before applying a new sheet of weatherproofing material.

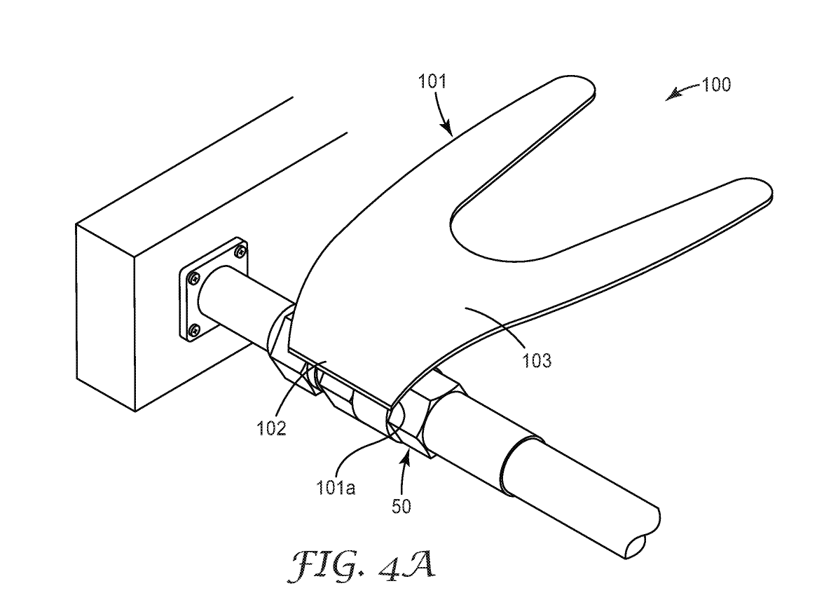

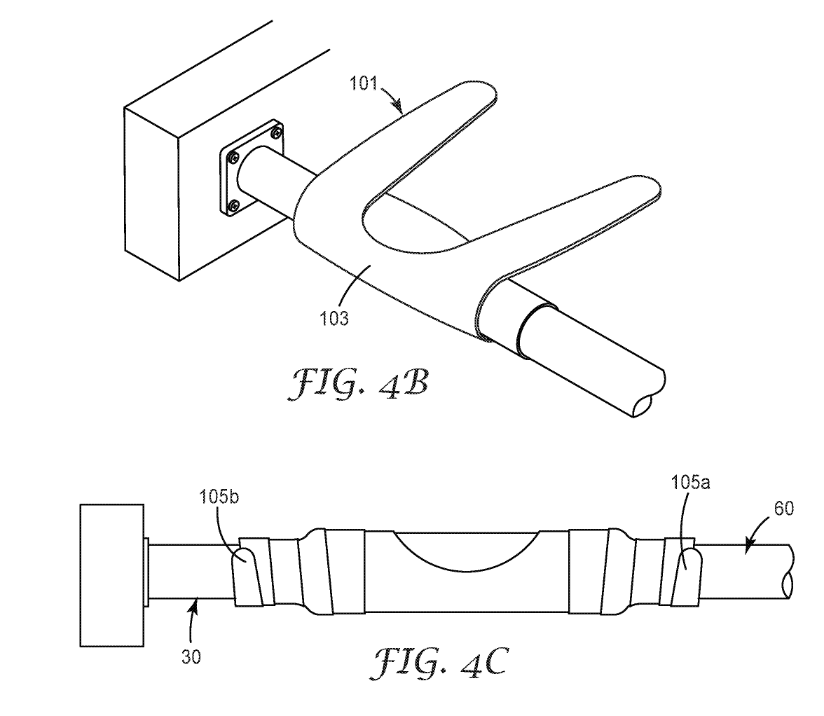

In one aspect, the sheet of weather proofing material can be wound around the cable connection by hand. For example, preformed sheet 101 of FIG. 3A can be used. To begin the installation process, the release liner 111 can be peeled back from the first end of preformed sheet of the weatherproofing material 100 to expose the compliant layer 109 of nose portion 102. The nose portion of the preformed sheet 101 of weatherproofing material 100 is adhered to a central portion of connector 50 as shown in FIG. 4A by the compliant layer in embodiments where the compliant layer is an adhesive or mastic. The preformed sheet is stretched as it is wrapped around the circumference of connector 50. Body portion 103 of the weatherproofing adopts a cylindrical wrap configuration around the central portion the cable connection as shown in FIG. 4B.

The craftsman removes the release liner from the surface of the compliant layer as he continues to wrap the cable connection with the weather proofing sheet. After the body portion has been wrapped around the central portion of the cable connection, the craftsman continues wrapping and stretching the weatherproofing material around the cable connection until the entire length of the tail portions has been used. The tail portions 105a, 105b of the preformed sheet adopt a helical wrap configuration on either side of the central portion the cable connection with each subsequent wrap layer covering a little more of the cable connection as shown in FIG. 4C.

Tension is applied to the weatherproofing material as it is applied over the cable connection stretching the preformed sheet and ensuring the sealing of the cable connection. In particular, the stretching of the tail portions prevents the formation of a leak path between layers of the helically wrapped portions of the cable connection. The length and width of the tail portions as well as the modulus of the composite preformed sheet determines the radial compression force exerted on the ends of the cable connection which can cause the compliant layer material to flow and fill in any gaps or leak paths formed during installation of the weatherproofing material. The ability to seal gaps between weatherproofing material and the contours of the connector as well as preventing gaps between adjacent wrap layers is due to the exemplary properties of the weatherproofing material. Key properties of the material can include the thickness, flexibility, strength and elongation properties of the substrate layer and the thickness, compliance/softness and the adhesive properties of the compliant layers. The adhesive properties can include adhesion to the material from which the connector material is made (e.g. brass, or stainless steel) or the connector can have a silver, nickel, or bronze plated surface, adhesion to cable jacket materials (e.g. polyethylene cable jacket materials, polyvinylchloride cable jacket materials and the like) adhesion to the substrate layer, as well as inter-compliant layer adhesion for the three layer weatherproofing materials. The substrate layer should have sufficient strength even after substantial elastic or inelastic deformation so that the substrate layer can apply sufficient force to the compliant layer(s) to fill any gaps between the weatherproofing sheet and the connector or cable as well as between adjacent wrap layers. The substrate layer provides a compressive force to the compliant layer(s) which can cause the compliant material to flow into any gaps formed due to variations in the circumference along the cable connection or gaps formed between adjacent wrap layers when the weatherproofing sheet is wrapped around a cable connection.

Once the tail portions are completely wrapped around the ends of the cable connection, the protection of the cable connection is complete. There is no need for additional wrapping with secondary or tertiary weatherproofing materials saving time and cost of materials over other conventional wrapping processes.

In exemplary practice, the wrap of the tail portions 105a, 105b extends on to the bulkhead receptacle 30 and over a portion of the cable 60 on either side of the connector to ensure a high level of protection for the connection point between the connector and the bulkhead receptacle.

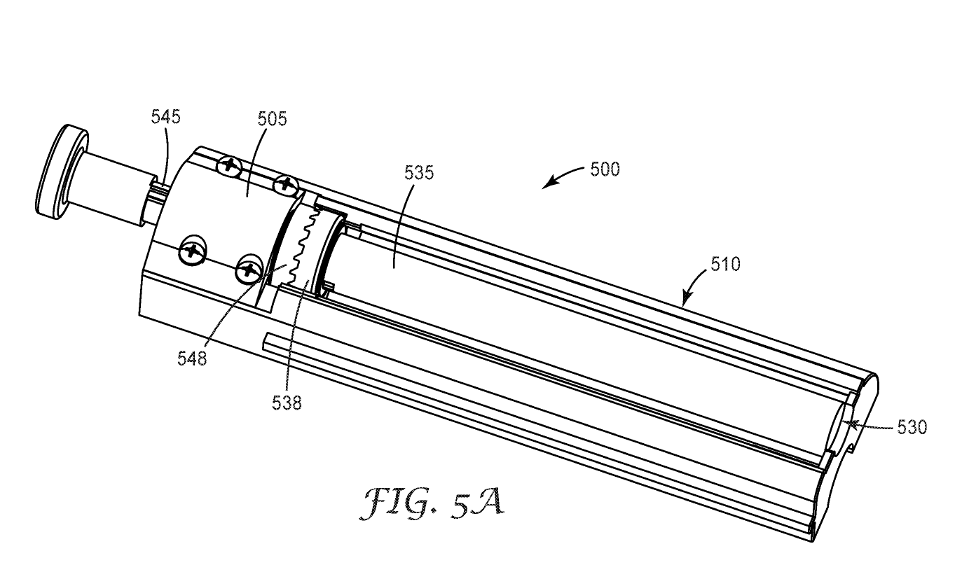

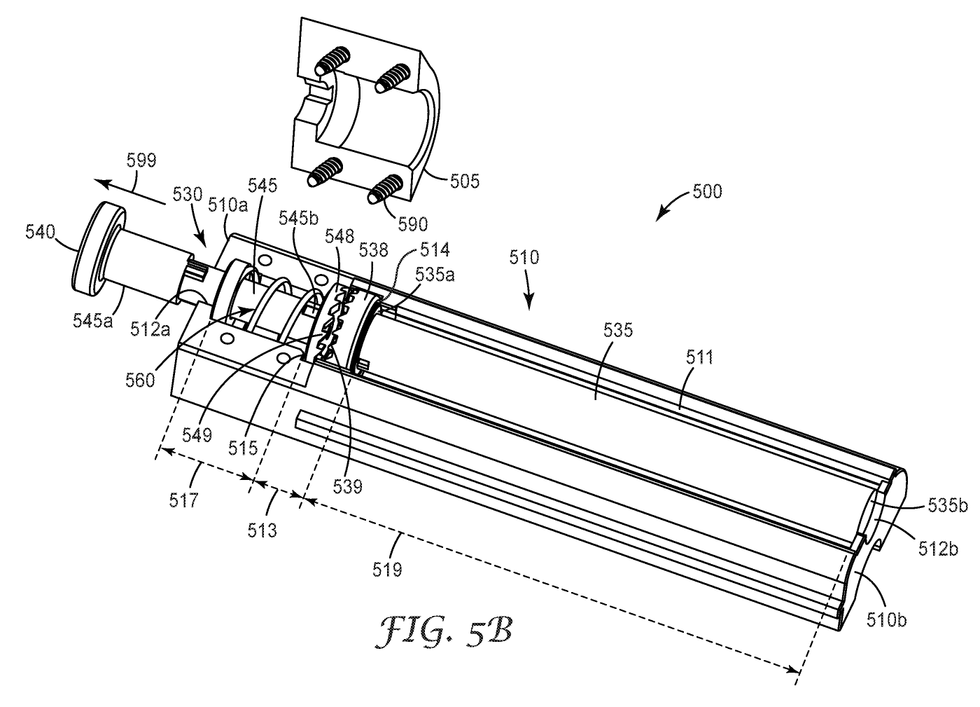

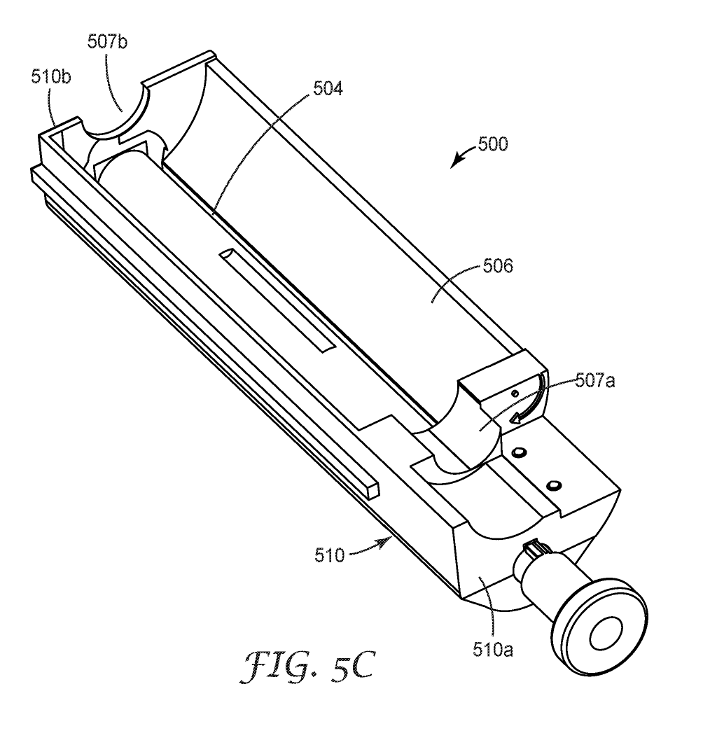

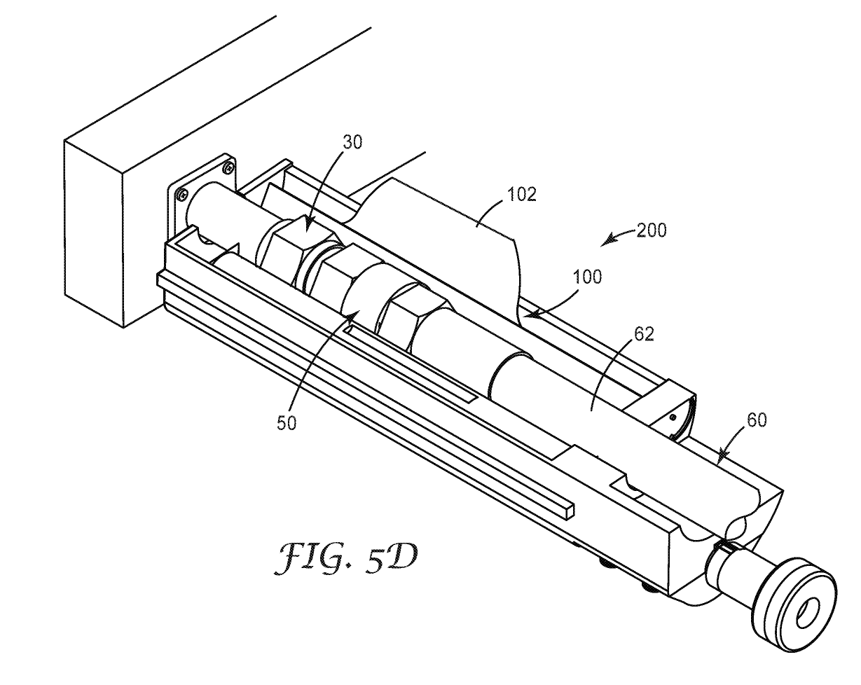

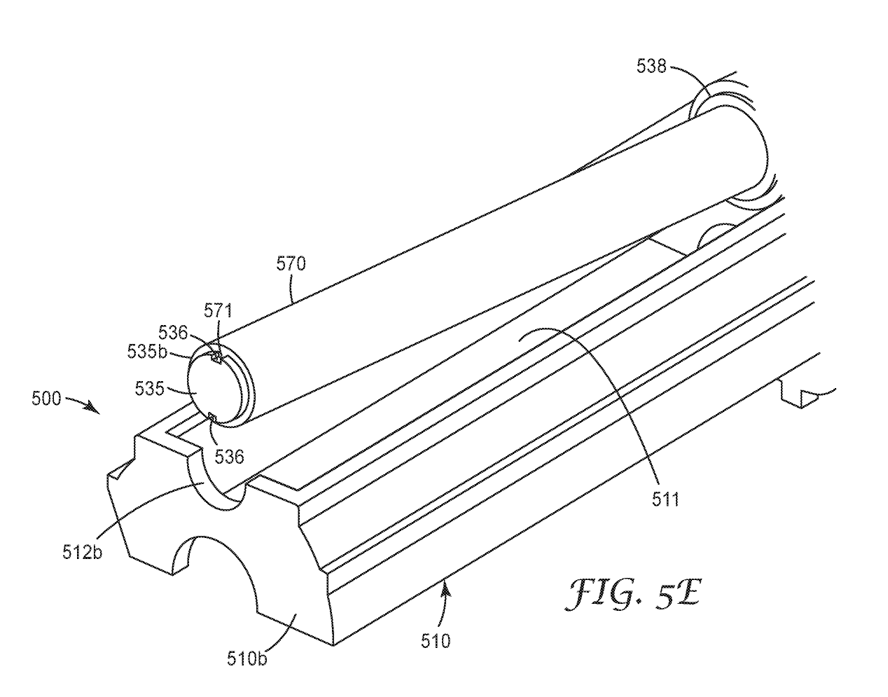

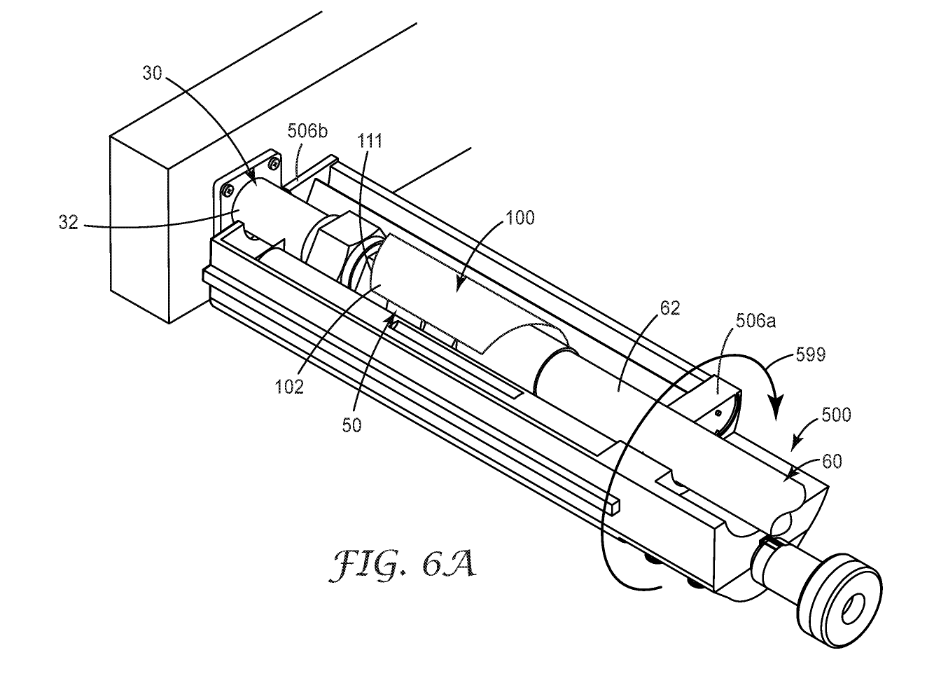

In an alternative aspect an applicator tool can be used to facilitate the wrapping of the weatherproofing material around the cable connection. FIGS. 5A-5E show an exemplary applicator tool 500 for applying a sheet of weatherproofing material to a cable connection. The exemplary tool uses a constant application force to controllably stretch the weatherproofing material as it is wrapped around the cable connection to ensure proper sealing of the material over the cable connection. Applicator tool 500 has a brake roller 530 supported in an applicator housing 510 such that the brake roller is in substantially non-slipping mechanical contact with the weatherproofing material when the weatherproofing material is disposed in the applicator tool. During installation of the weatherproofing material over a cable connection, the brake roller rotates at a circumferential speed that is less than the magnitude of an application speed of the weather proofing material to the cable connection resulting in controlled stretch and tensioning of the weatherproofing material.

Brake roller 530 includes a spool configured to hold the weatherproofing material 535, a first ratchet disk 538 mounted to the first end 535a of the spool, and a second ratchet disk 548 mounted to the second end 545b of the spindle 545. The first and second ratchet disks provide substantially controlled, sliding mechanical contact when the first and second ratchet disks are engaged. A tensioning spring 560 can be disposed around a spindle to control the application force that is applied to the weatherproofing material by the tool. In one aspect, each of the first and second ratchet disks comprise a plurality of inclined teeth 539, 549, respectively formed on one surface of the ratchet disk such that the plurality of inclined teeth on the first ratchet disk and the plurality of inclined teeth on the second ratchet disk engage to provide the substantially controlled, sliding mechanical contact or the brake roller. The angle of the inclined teeth on the first and second ratchet disks determine how large of a tension spring is required to generate a specific drag torque. For example, inclined teeth having an angle of 45° will require a smaller spring force than inclined teeth having an angle of 30°. The plunger 540 can be disengaged from the spool so that the spool can be rotated and the CFA leader located properly for installation. Those skilled in the art will recognize that other means of creating a braked roller have been devised and are considered to fall within the scope of this invention. Moreover, other means of controllably tensioning a weatherproofing material during installation are possible.

The length of the spool should be sufficient to allow the wrap of the weatherproofing material to extend onto the bulkhead receptacle on one side of the cable connection and onto the jacket of the cable on the other side of the cable connection. In another aspect, the length of the spool should be greater than or equal to the maximum width of the sheet weatherproofing material to be used in the tool. The weatherproofing material may be wound directly around the spool or weatherproofing material can be wrapped on a core that can be slid onto the spool prior to inserting the spool in the applicator tool.

As previously mentioned, the exemplary weather proofing sheet can be supplied on a plastic or cardboard core. FIG. 5E shows a cylindrical core 570 disposed on the spool 535 after the weather proofing sheet has been installed over a cable connection. The core should not slip relative to the spindle when the application force is applied to the weather proofing sheet over the cable connection. To prevent this slippage, the core can be keyed to the spool. In the aspect shown in FIG. 5E, a pair of longitudinal grooves 536 are formed in the surface of the spool. The core has matching longitudinal ridges 571 formed on the interior surface of the core. The ridges fit within the longitudinal groove when the weather proofing material is loaded into the applicator tool preventing the core from slipping relative to the spool when tension (i.e. due to the application force) is applied to the weather proofing material. Other keying features can exist between the spool and the core to prevent the core from slipping relative to the spool. For example, the spool can include at least one partition (not shown) disposed near the first end of the spool that engages with a notch or cutout (not shown) in the end of the cylindrical core to prevent the core from slipping relative to the spool.

Applicator tool can further include a plunger 540 disposed on a first end of the spindle. Pulling the plunger back in a direction indicated by arrow 599 in FIG. 5C allows the spool carrying the weatherproofing material to be installed in the applicator tool. Releasing the plunger allows the plurality of inclined teeth 539, 549 on the first and second ratchet disks 538, 548 to engage.

A second function of the plunger 540 may be to provide a means for adjustment of the spring force by rotating the plunger, thereby compressing or extending the tension spring.

The applicator housing includes a first compartment 511 configured to hold the brake roller and a second compartment 506 that is configured to accept the cable connection during installation of the weatherproofing material over the cable connection. There is a slot 504 between the first and second compartments to allow the weather proofing material to pass from the spool onto the cable connection during installation of the weatherproofing material onto the cable connection.

The first compartment 511 can include three sections: a material holding section 519 disposed between the second end 510b of the applicator housing 501 and a first interior rib 514, a ratchet section 513 disposed between the first interior rib and the second interior rib or shoulder 515, and a tensioning section 517 disposed between the second interior rib and the first end 510a of the applicator housing. The material holding section of the first compartment can have a first recess 512a formed in the first end 510a of the applicator housing 510 to allow the spindle 545 to pass through the first end of the applicator housing and a second recess 512b formed in the second end 510b that is configured to receive and hold the second end of spool 530 via a snap fit. The internal dimensions of the second recess is sufficiently larger than the external circumference of the spool such that the spool may rotate when held within the second recess.

The first and second ratchet disks 538, 548, respectively, are disposed in the ratchet section 513 between the first and second interior ribs 514, 515, respectively. The distance between the first and second interior ribs should be sufficient to allow the second ratchet disk to be pulled back by the plunger 540 to allow easy insertion of the spool with the first ratchet disk disposed thereon into the first compartment.

The tensioning section 517 provides a cavity to hold the tensioning spring 560 that is disposed around spindle 545 and can include an optional cover 505 to enclose the tensioning section and the tension spring therein. The tension spring defines the application force that will be applied to the weather proofing material as it is installed over the cable connection. The application force exerted should be sufficient to stretch the weather proofing material as it is applied around the cable connection so that it can substantially conform to the external profile of the cable connection to which it is being applied. The application force is controlled by the amount of force being applied to the second ratchet disk 548 disposed on the spindle 545 by the tension spring. The tension spring 560 causes the inclined teeth 549 on the second ratchet disk to engage with the inclined teeth 539 of the first ratchet disk 538 disposed on the spool 535. As the applicator tool is moved around the cable connection, the spool will not turn until the tensioned weatherproofing material creates sufficient force to overcome the spring force of the tension spring allowing a small longitudinal movement in the second ratchet disk so that the teeth of the first and second ratchet disks can slip by one another allowing the spool to move rotationally by a small amount. The amount of rotational movement at each step is determined by the pitch of the teeth on the ratchet disks. The ratchet gears will click as the tool is rotated around the cable connection providing the craftsman with an audible indication that the weatherproofing material is being properly installed. In an exemplary aspect, the applicator tool can be moved around the cable connection at about 1-2 clicks per second.

The applicator tool will stretch the preformed sheet of weatherproofing material as it is installed over the cable connection. Since the weather proofing material is stretching as it is applied, the brake roller rotates at a circumferential speed that is less than the application speed. This speed differential allows the exemplary applicator tool to control the stretching and tensioning of the weatherproofing material as it is applied to the cable connection. The amount of stretching and tensioning of the weatherproofing material is controlled by the drag force applied by the braked roller. The drag force in turn, is controlled by the stiffness of the chosen tension spring 560. The drag force can be chosen by application, e.g. installation by hand or installation by a separate torque applying tool. In the case of hand installation, the value of the drag force should lie between the force required for sealing the compliant layer and the maximum force that a typical installer could apply by hand. For hand installation, the drag force should lie between 2 pounds and 40 pounds and preferably between 5 pounds and 25 pounds.

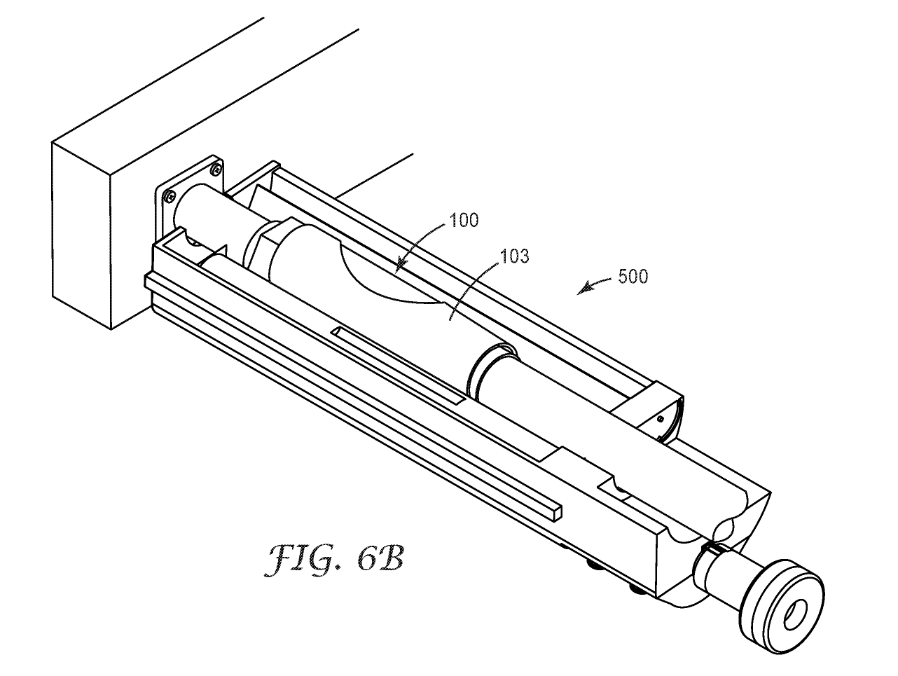

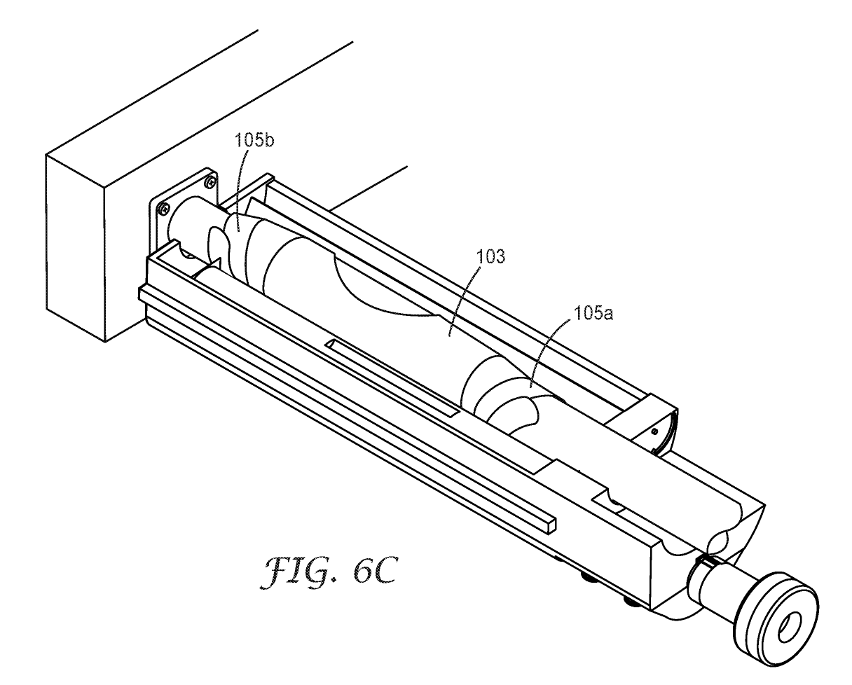

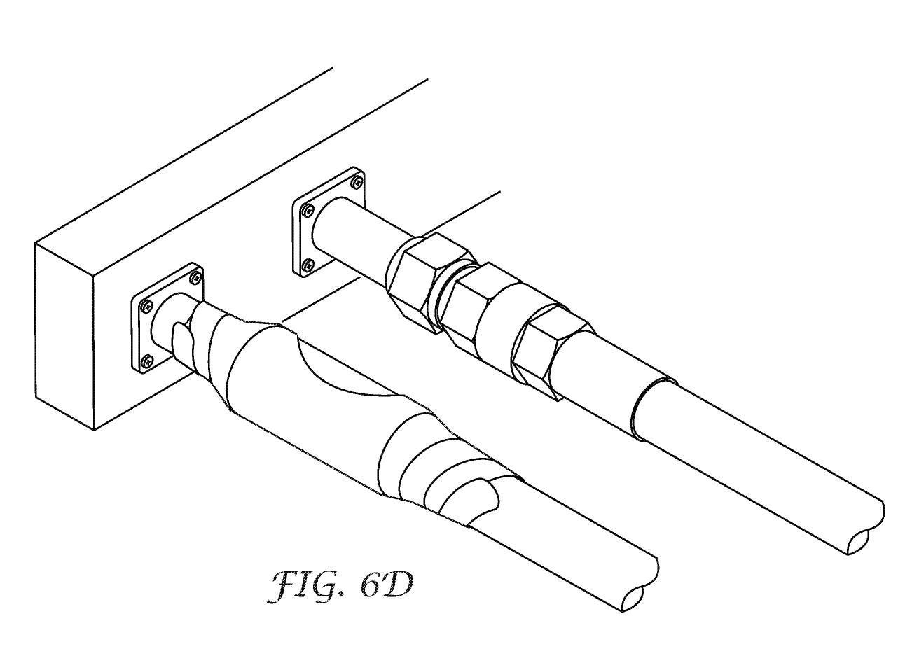

Second compartment 506 for holding the cable connection during installation of the weatherproofing material is shown in FIG. 5D. The second compartment includes a first cradle 507a near the first end 510a of the applicator housing 510 to engage with a jacket portion 62 of cable 60 on the one side of the cable connection and a second cradle 507b at the second end 510b of the applicator housing to engage with a bulkhead receptacle 30 on the other side of the cable connection, thus providing proper positioning of the cable connection within the applicator tool 500 as shown in FIG. 6A.

The exemplary applicator tool has a compact size so that the tool can fit in between two closely adjacent cable connections. In addition, the external contour of the applicator tool is designed for the comfortable application of torque by having a shape that fits well within a person's hand.

FIGS. 5A-5E and 6A-6D illustrate the installation of an exemplary sheet of weatherproofing material over a cable connection. To use the exemplary applicator tool, a sheet of the weatherproofing material is loaded onto the spool 535 of the brake roller by aligning the ridges 571 on the inside of the core 570 with the longitudinal grooves 536 formed in the spool and sliding the core onto the spool until it rests against the first ratchet disk 538 (FIG. 5E). Alternatively, the sheet of the weatherproofing material can come preloaded on a spool from the supplier. The spool can be inserted into the first compartment 511 of the applicator tool 500 by pulling on the plunger 540 and rotating in the direction indicated by arrow 599 to retract the ratchet disk on the spindle 545 to provide sufficient space to insert the spool. The spool is inserted into the first compartment of the applicator tool by snapping second end 535b of the spool into the second recess 512b formed in the second end 510b of the applicator housing 510 that is configured to receive and hold the second end of spool 530 via a snap fit and then placing the first ratchet disk on the spool in the ratchet section 513 between the first interior rib 514 and the second ratchet disk 548. The inclined teeth 539, 549 of the first and second ratchet disks can be engaged by releasing the plunger. The nose portion 102 of the weatherproofing sheet 101 is passed through slot 504 between the first and second compartments to prepare for the installation of the weatherproofing material onto the cable connection.

Next, the cable connection is placed into the second compartment 506 of the applicator housing 510 such that a jacket portion 62 of cable on the one side of the cable connection is disposed in the first cradle 506a at the first end of the first compartment 506 and the shank 32 of the bulkhead receptacle 30 on the other side of the cable connection is disposed in the second cradle 506b at the second end 510b of the applicator housing. Thus, connector 50 lies between the first and second ends of the applicator housing as shown in FIG. 6A.

If present, release liner 111 can be peeled back from the nose portion 102 at the first end of preformed sheet of the weatherproofing material 100 to expose the compliant layer. The nose portion of the preformed sheet 101 of weatherproofing material 100 is adhered to a central portion of connector 50 as shown in FIG. 6A by either the compliant layer in embodiments where the compliant layer is a pressure sensitive adhesive or mastic or by a piece of double sided adhesive tape when the compliant layer does not have sufficient green strength when applied to the connector.

As applicator tool 500 is rotated around the cable in a direction indicated by arrow 599, the applicator tool applies a constant application force to the sheet of weatherproofing material. The force exerted is sufficient to stretch the weather proofing material as it is applied around the cable connection. The application force is controlled by the amount of force being applied to the second ratchet disk 548 disposed on the spindle 545. The tension spring 560 causes the inclined teeth 549 on the second ratchet disk to engage with the inclined teeth 539 of the first ratchet disk 538 disposed on the spool 535. As the applicator tool is moved circumferentially around the cable connection, the spool will not turn until the tensioned weatherproofing material creates sufficient force to overcome the spring force of the tension spring allowing a small longitudinal movement in the second ratchet disk to allow the teeth of the first and second ratchet disks to slip by one another allowing the spool to move rotationally by a small amount. The amount of rotational movement at each step is determined by the pitch of the teeth on the ratchet disks. The ratchet gears will click as the tool is rotated around the cable connection providing the craftsman with an audible indication that the weatherproofing material is being properly installed.

The body portion 103 of the weatherproofing material adopts cylindrical wrap configuration as it is wrapped around the central portion the cable connection as shown in FIG. 6B. If present, the craftsman can remove the release liner 111 from the surface of the compliant layer as he continues to wrap the cable connection with the weather proofing sheet 101 by continuing to rotate the applicator tool 500 around the cable connection. After the body portion has been wrapped around the central portion the cable connection, the craftsman continues wrapping and stretching the weatherproofing material around the cable connection until the entire length of the tail portions has been used. The tail portions 105a, 105b of the preformed sheet adopt a helical wrap configuration on either side of the central portion of the cable connection with each subsequent wrap layer covering a little more of the cable connection as shown in FIG. 6C. FIG. 6D shows the final protected cable connection.

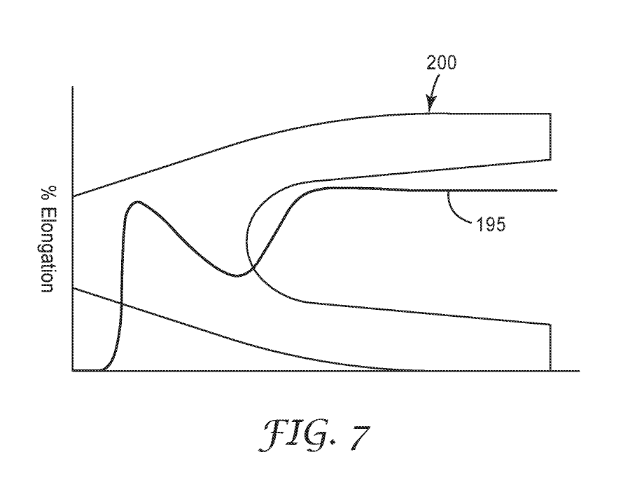

The installation process described above utilizes a single sheet of weatherproofing material as compared with conventional processes which can use three or more materials. The shape and properties of the weather proofing material in conjunction with applicator tool provides controlled elongation or stretching and tensioning of the preformed sheet of weatherproofing material. FIG. 7 shows an idealized elongation profile 195 of an exemplary preformed sheet of weather proofing material when it is applied over a cable connection by the exemplary applicator tool. The figure illustrates how intentional design of the material profile can allow different portions of the wrap to be installed with varying tension. In the profile of FIG. 7, the helical wraps of the tail portion wrap at higher tension than the cylindrical wraps of the body portion. This allows for greater compression force to be created at the bulkhead end and at the cable end of the wrap. Since most leaks occur at these two locations, such intentional design of the material profile provides a great improvement in the robustness of the waterproofing seal created by the waterproofing material.

Use of the applicator tool can eliminate variations in the wrapping of the cable connection since the tool is simply moved around the cable connection. The shape of the preformed sheet determines the way the cable connection is wrapped. The cylindrical wrap of the body portion of the sheet quickly applies the weather proofing material to the central portion of the cable connection in just a few rotations of the tool around the cable connection (i.e. 1-3 rotations of the tool around the cable connection). The applicator tool then seamlessly moves on to simultaneously helically wrap the tail portions of the weatherproofing material around the ends of the cable connection with just a few additional rotations of the applicator tool around the cable connection (i.e. 2-5 additional rotations of the applicator tool). The craftsman no longer has to worry about maintaining the correct pitch of the helical wrap since the design of the preformed sheet of weatherproofing material determines pitch and the applicator tool ensures that the correct amount of force is applied to the weatherproofing material to ensure the necessary environmental protection.

When doing field installations of the exemplary weather proofing solution, the temperature conditions may vary which can affect the force needed to reliably install the exemplary weatherproof material on a cable connection. For example, the exemplary weatherproofing solution may need to be installed over a cable connection at temperatures between about −10° C. and 40° c., and possibly as low as −20° C. At higher temperatures, a lower application force will be needed, while at cold temperatures a higher application force will be required. An exemplary tool can include a tension adjustment mechanism to ensure optimal installation of the weatherproofing material regardless of the installation temperature.

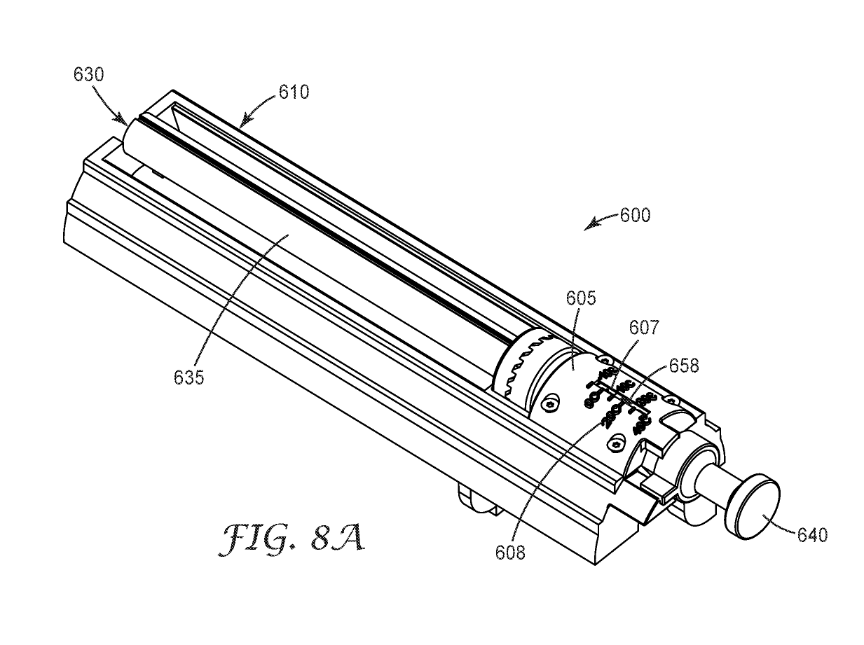

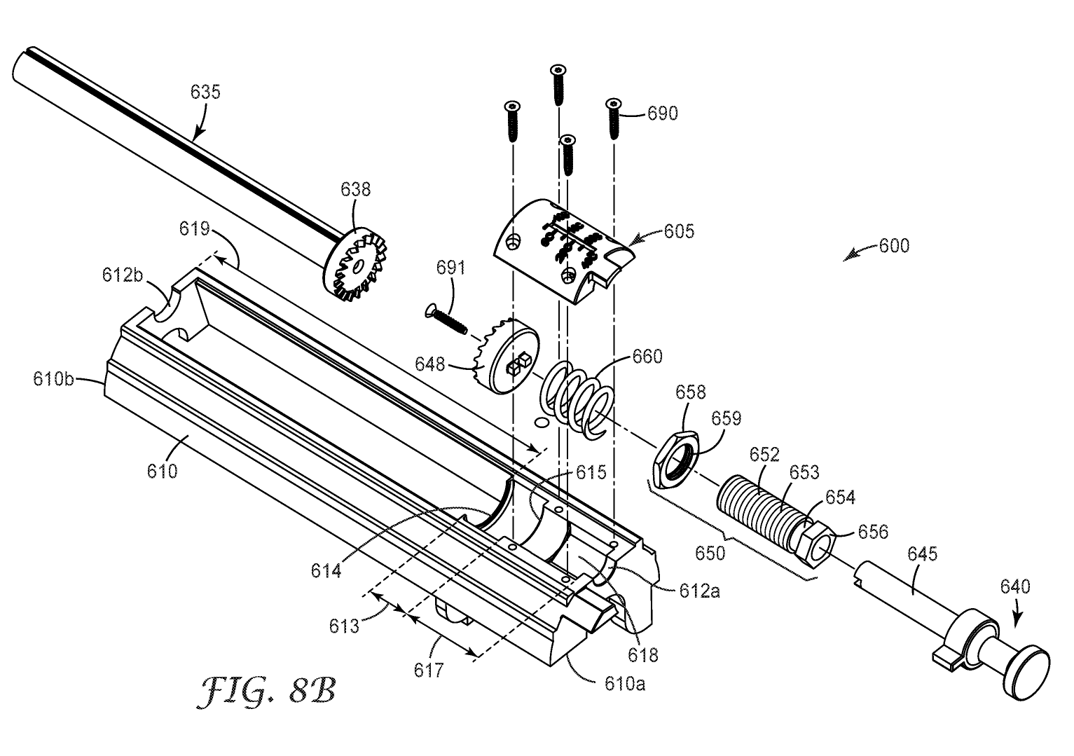

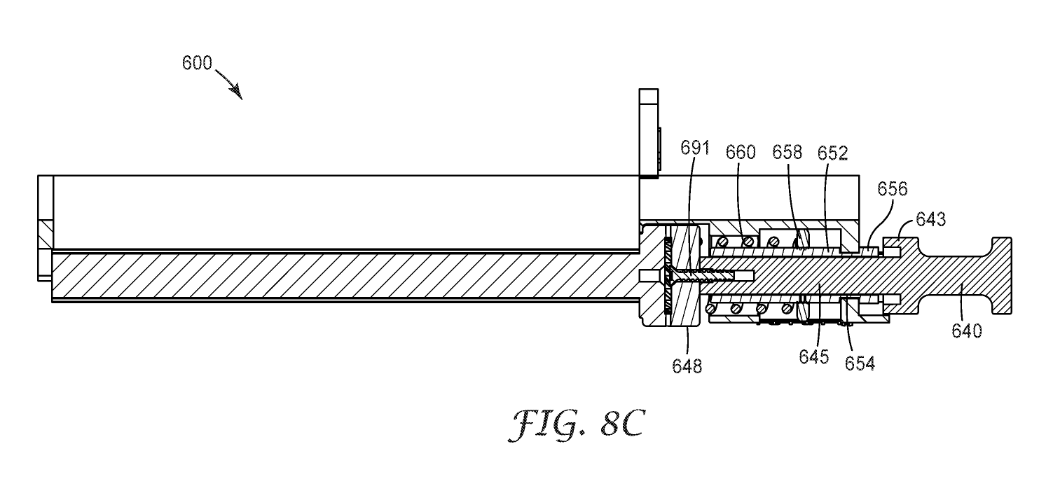

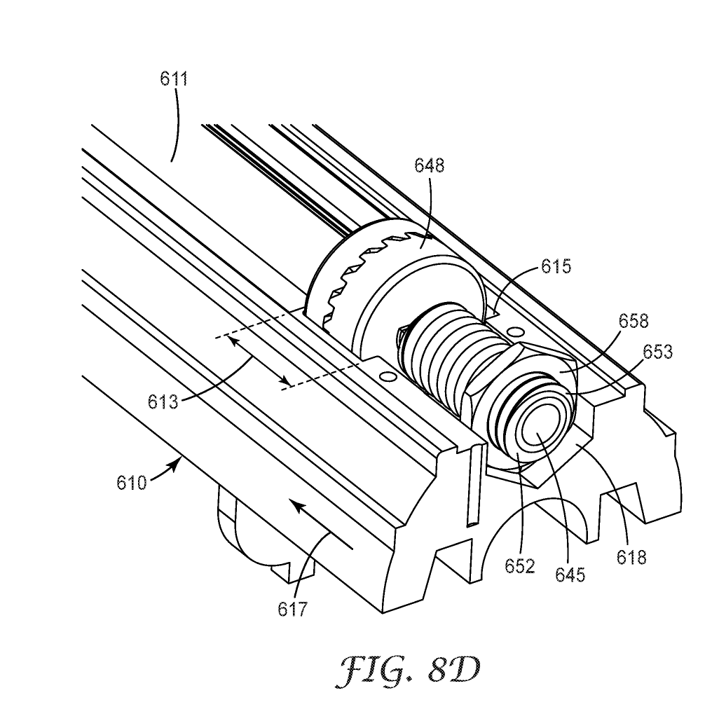

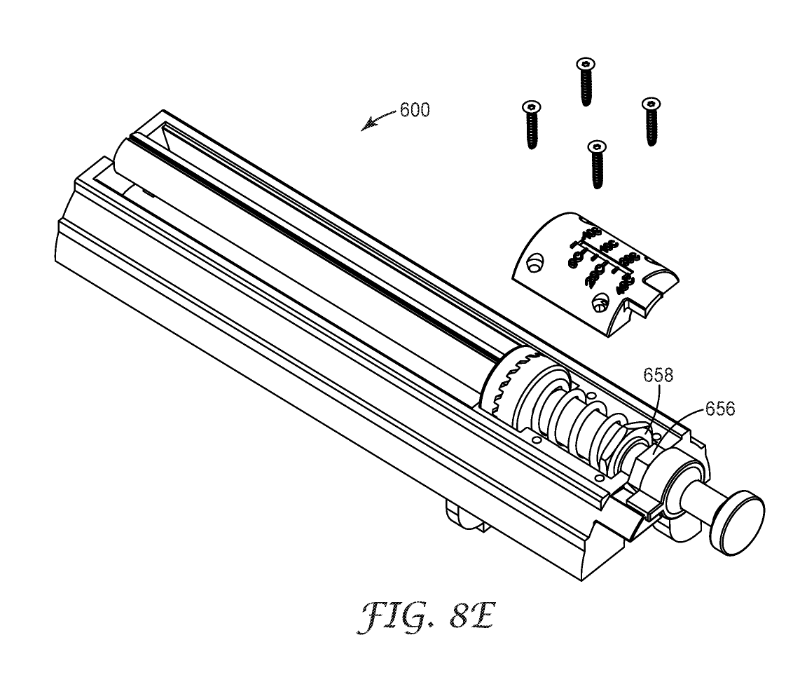

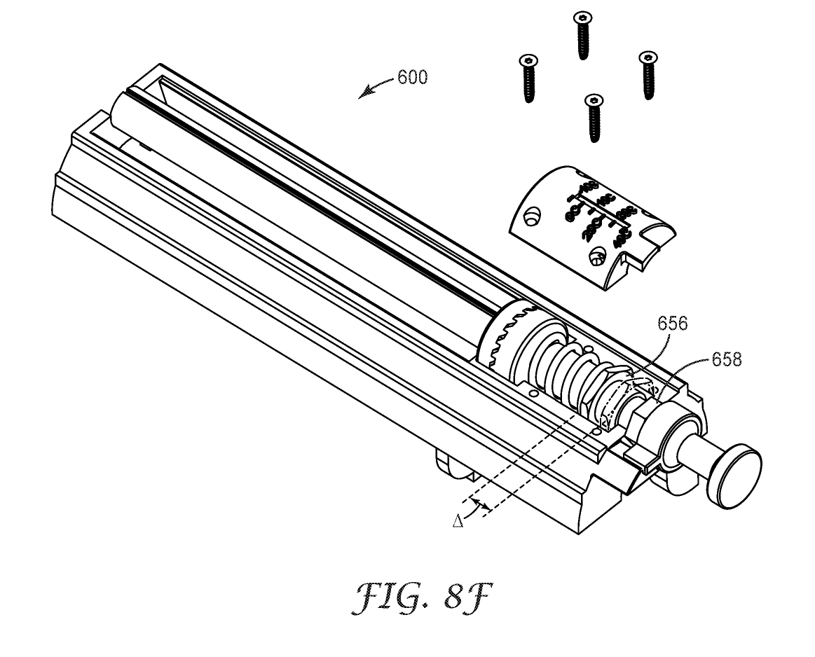

FIGS. 8A-8F show an alternative applicator tool 600. Applicator tool 600 includes a brake roller 630 supported in an applicator housing 610. The applicator housing includes a first compartment 611 configured to hold the brake roller and a second compartment (not shown) configured to accept the cable connection during installation of the weatherproofing material over the cable connection. Note that the second compartment in applicator tool 600 is analogous to second compartment 506 of applicator tool 500 shown in FIG. 5C. There is an opening or slot 604 between the first and second compartments to allow the weather proofing material to pass from the spool onto the cable connection during installation of the weatherproofing material onto the cable connection.

The first compartment 611 can include three sections: a material holding section 619 disposed between the second end 610b of the applicator housing 601 and a first interior rib 614, a ratchet section 613 disposed between the first interior rib and the second interior rib or shoulder 615, and a tensioning section 617 disposed between the second interior rib and the first end 610a of the applicator housing. The material holding section of the first compartment can have a first recess 612a formed in the first end 610a of the applicator housing 610 to allow the spindle 645 to pass through the first end of the applicator housing and a second recess 612b formed in the second end 610b that is configured to receive and hold the second end of brake roller via a snap fit. The internal dimensions of the second recess is sufficiently larger than the external circumference of the spool such that the spool may rotate when held within the second recess.

Brake roller 630 includes a spool 635 configured to hold the weatherproofing material, and a spindle 645 generally as described previously in relation to applicator tool 500 shown in FIGS. 6A-6D. In addition, applicator tool 600 includes a tension adjustment mechanism 650.

In the exemplary embodiment shown in FIGS. 8A-8E, Spool 635 is integrally formed with the first ratchet disk 638 thus reducing the total part count for applicator tool 600.

The spindle 645 and plunger can also be formed as a single integral part. The second ratchet disk can be attached to the free end of the spindle opposite the plunger by a snap fit, mechanical keying or by a mechanical fastener such as screw 691 shown in FIGS. 8C and 8C.

The tension adjustment mechanism 650 acts to lengthen and shorten the tension spring 660 which in turn adjusts the braking force that the tool applies to the sheet of weatherproofing material. The tension adjustment mechanism 650 include a sleeve 652 that fits over the spindle 645 and an adjuster nut 658 that can move up and down the length of the sleeve to adjust the length of the tension spring. Sleeve 652 is sized so that it can freely rotate around spindle when the tension adjustment mechanism is engaged. In an exemplary aspect, the sleeve includes external threads 653 disposed on a portion of its outer surface and a hexagonal setting feature 656 disposed on one end of the sleeve. The adjuster nut 658 includes internal threads 659 that engage with the external threads on the sleeve. Sleeve 652 also includes a circumferential channel 654 formed in the outer surface of the sleeve.

When assembled, adjuster nut 658 is threaded onto the sleeve so that it is positioned close to the hexagonal setting feature 656. Then the sleeve is fitted over the spindle and the tension spring is fit over the sleeve so one end of the tension spring rests against the adjuster nut. Finally, the second ratchet disk is mounted on the free end of the spindle such that the second end of the tension spring rests against the top face of the ratchet disk. Tightening screw 691 places the prescribed preload on the tension spring.

When placed into the first compartment of the applicator tool, the second ratchet disk is disposed in the ratchet section 613 such that the top surface of the second ratchet disk is positioned adjacent to shoulder 615 as shown in FIG. 8D. The tension spring is disposed in tensioning section 617 disposed between the top surface of the second ratchet disk and adjuster nut 658. The adjuster nut is positioned in a close fitting portion 618 of the tensioning section which allows the adjuster nut to travel longitudinally along the length of sleeve 652, but does not allow the adjuster nut to rotate within the housing. The cover 605 for the tensioning section can have a complementary close fitting shape in the close fitting portion 618 of the tensioning section. The circumferential channel 654 of the sleeve engages with first recess 612a of the applicator housing to aid in the positioning of the spindle assembly in the applicator tool.

In an exemplary aspect shown in FIGS. 8A-8F, plunger 640 can include a socket feature which can engage with hexagonal setting feature 656 on the sleeve to engage the tension adjustment mechanism 650. Turning the hexagonal setting feature causes the sleeve to turn. Because adjuster nut 658 is rotationally constrained, it will travel longitudinally along the length of the sleeve either lengthening or shortening the length of the spring which in turn adjusts the amount of force exerted on the top face of the second ratchet disk 648.

At warm temperatures the weather proofing material will be softer and more flexible than at cooler temperatures thus a lower application force is needed to properly install the weather proofing material around the cable connection. To achieve a lower application force, the force that the tension spring exerts on to the second ratchet disk can be proportionally lower. FIG. 8E shows the application tool set for warm conditions, i.e. adjuster nut 658 is disposed relatively close to the hexagonal setting feature 656. FIG. 8F shows the application tool set for cold conditions, i.e. tension spring has been shortened by a distance Δ. Cover 605 includes a slot 607 so that the craftsman can visually verify the position of adjuster nut 658 as shown in FIG. 8A. In an exemplary aspect, indicia can be formed in the cover 608 that correlate the position of the adjuster nut to the application temperature when the weatherproofing material is installed on the cable connection.

### EXAMPLES

### Test Methods

### Sealing Performance

Sealing performance was tested by placing a wrapped coaxial cable connection into a tank of water at 1 m below the surface (at 1.71 psi or 11.8 kPa) for 1 hour. The samples were removed and the external moisture dried off with a towel. Then the wrapped waterproofing material was removed from the cable connection and the cable connection examined for signs of water penetration.

### Adhesion

Samples were die cut to dimensions of 25.4 mm×95.2 mm (1 in.×3.75 in.). Samples were adhered to a stainless steel sample plate 152 mm×50.8 mm (6 in.×2 in.). The stainless steel sample plate was cleaned prior to use and between sample measurements using 2-butanone followed by heptane. Release liners were removed from all samples prior to testing. Samples were adhered to the stainless steel plate 25.4 mm×82.5 mm (1 in×3.25 in) so that 25.4 mm×12.7 mm (1 in.×0.5 in.) of the sample was available for securing into a clamp. A 180 degree peel test was conducted using a 10 lb load cell with a peel rate of 12 in/min using an MTS Insight 5 available from MTS Systems (Eden Prairie, Minn.). Peel force (oz) was measured using a 4 second time delay and a 20 second total peel time.

### Tensile Strength and Percent Elongation

Tensile and elongation mechanical testing was conducted using a MTS Insight 5 available from MTS Systems (Eden Prairie, Minn.) with 1000N load cells and a travel speed of 12 inches/minute. A normal dog bone specimen with the following dimensions was used for the analysis: gauge length=1.5 inches, gauge width=0.25 inches, distance between shoulders=2.5 inches, overall length=4.5 inches, width of grip section=1.0 inches.

### Examples

### Example I

A two layer preformed sheet of weatherproofing material was cut from a 4 inch wide roll of from Scotch® Vinyl Mastic Tape 2210 available from 3M Company (St. Paul, Minn.).

The final thickness of the preformed sheet was 91 mils (2.3 mm) having a substrate layer thickness of about 8 mils (0.2 mm) and compliant layer thicknesses of 83 mils (2.1 mm) each thickness.

### Example II

A two Layer preformed sheet of weatherproofing material was cut from a 4 inch wide roll of from Scotch® Electrical moisture Sealant 06147 available from 3M Company (St. Paul, Minn.).

The final thickness of the preformed sheet was 45 mils (1.14 mm) having a substrate layer thickness of about 7 mils (0.18 mm) and compliant layer thicknesses of 38 mils (0.96 mm) each thickness.

### Example III

Texin® 1209 Thermoplastic Polyurethane Elastomer (Polyether) resin available from Bayer Material Science (Pittsburgh, Pa.) was extruded on silicone coated paper liner to a thickness of 1.5 mil. A 1.0 mil thick acrylate-based adhesive (97/3; Isooctyl acrylate/acrylamide) was coated on the Texin film. Sheets of the Texin 1209 film/adhesive (6″×24″) were sequentially laminated to provide a six-layer film/adhesive composite. A 1 mil transfer adhesive (97/3; Isooctyl acrylate/acrylamide) was then applied to the top film layer (no adhesive) to produce a multi-layer stack comprising alternating substrate and compliant layers and having two compliant external layers (i.e. 1 mil 97/3; Isooctyl acrylate/acrylamide adhesive layers on the outer surface of the stack).

TABLE 1
Summary of Examples

| | Example I | | Example II | | Example III | |
|---|---|---|---|---|---|---|
| Compliant Layer(s) | Rubber based mastic | | Rubber based mastic | | Acrylate-based PSA | |
| Material | | | | | | |
| Substrate Layer | PVC | | PVC | | Polyurethane | |
| Material | | | | | | |
| No. of Layers | 2 | | 2 | | 13 | |
| Thickness | 91 mils | (2.3 mm) | 45 mils | (1.14 mm) | 18 mils | (0.61 mm) |
| Adhesion | | | | | | |
| To steel | 200 oz./in.* | | 65 oz./in.* | | 18 oz./in. | |
| To PVC | | | 60 oz./in.* | | | |
| To PE | 200 oz./in.* | | | | | |
| Young's modulus | 1.30 MPa | (188 psi) | 2.76 MPa | (400 psi) | 1.34 MPa | (195 psi) |
| Elongation | 126% | (200%*) | 113% | (200%*) | 1683% | |
| Breaking Strength | 31.1N/cm | (21.2 lbs/in) | 39.9N/cm | (22.8 lbs/in) | 103.7N/cm | (59.2 lbs/in) |

| | | | |
|---|---|---|---|
| Application Method | Hand applied | Hand applied | Applicator tool |
| Sealing Performance | Pass | Pass | Pass |

*values obtained from manufacturer data sheet

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A weather-proofing solution for a cable connection, comprising:
a preformed sheet of weatherproofing material wherein the preformed sheet comprises a body portion and two spaced apart tail portions extending longitudinally from one end of the body portion, wherein an inside edge of each of the tail portions flares away from a centerline of the preformed sheet by an angle, θ, in a range of 0°<θ<30°, allowing the tail portions to spread away from the centerline when wrapped and initiating a helical wrapping pattern as the tail portions are wrapped around the ends of the cable connection and wherein the preformed sheet has a variable elongation along its length when wrapped around the cable connection under a substantially constant force.

2. (canceled)

3. The weather-proofing solution of claim 1, wherein the body portion is configured to cylindrically wrap around a central portion of the cable connection.

4. The weather-proofing solution of claim 1, wherein the preformed sheet of weather proofing material comprises a flexible and elastic substrate layer and a first compliant layer disposed on a major surface of the substrate layer.

5. The weather-proofing solution of claim 4, wherein the preformed sheet further comprises a second compliant layer disposed on another major surfaces of the substrate layer opposite the first compliant layer.

6. The weather-proofing solution of claim 4, wherein at least one of the first and second compliant layers is one of a pressure sensitive adhesive and a mastic material.

7. (canceled)

8. The weather-proofing solution of claim 1, wherein preformed sheet has a non-uniform elongation profile.

9. The weather-proofing solution of claim 4, wherein the preformed sheet further comprises a release liner disposed over the first compliant layer.

10. An applicator tool for applying weatherproofing material to a cable connection, comprising:
a brake roller supported in an applicator housing, and
a preformed sheet of weather proofing material according to any of the precious claims disposed on a portion of the brake roller, wherein the brake roller is in substantially non-slipping mechanical contact with the weatherproofing material and wherein the brake roller rotates at a circumferential speed, such that the magnitude of the circumferential speed of the brake roller is less than the magnitude of an application speed resulting in controlled elongation and tensioning of the weatherproofing material.

11. The tool of claim 10, wherein the brake roller comprises
a spool configured to hold the weatherproofing material;
a first ratchet disk mounted to the first end of the spool;
a tensioning spring disposed around a spindle; and
a second ratchet disk mounted to the second end of the spindle, wherein the first and second ratchet disks engage to provide the substantially controlled, sliding mechanical contact when the first and second ratchet disks are engaged.

12. The tool of claim 11, wherein each of the first and second ratchet disks comprise a plurality of inclined teeth formed on one surface of the ratchet disk and wherein the plurality of inclined teeth on the first ratchet disk and the plurality of inclined teeth on the second ratchet disk engage to provide the substantially controlled, sliding mechanical contact.

13. The tool of claim 11, further comprising a plunger disposed on a first end of the spindle, wherein actuating the plunger engages and disengages the first and second ratchet disks.

14. The tool of claim 11, wherein the weather proofing material is provided on a core and wherein keying features exist on the spool and on the core to prevent the core from slipping relative to the spool during application of the weatherproofing material over the cable connection.

15. The tool of claim 11, further comprising a tension adjustment mechanism.

16. The tool of claim 15, wherein the brake roller comprises a spool configured to hold the weatherproofing material and a tensioning spring disposed around a spindle, wherein the tension adjustment mechanism includes a sleeve that fits over the spindle and an adjuster nut that travels along the length of the sleeve to adjust the length of the tension spring.

17. A method of applying a sheet of weather-proofing material to a cable connection, the method comprising:
providing an applicator tool having a brake roller supported in an applicator housing, and a preformed sheet of weatherproofing material disposed on a portion of the brake roller, wherein the preformed sheet comprises a substrate layer and a compliant layer on a major side of the substrate layer;
placing a cable connection in a second compartment of the applicator tool;
adhering a first end of the weatherproofing material to a central portion of the cable connection; and
winding the applicator tool around the cable connection with a constant application force such that a central portion of the cable connection is cylindrically wrapped by a first portion the weatherproofing material and a region on either side of the central portion is helically wrapped by a second portion the weatherproofing material.

18. The method of claim 17, further comprising removing a release liner from a surface of the compliant layer as the preformed sheet is wrapped around the cable connection.

19. The method of claim 17, further comprising adjusting a tension adjustment mechanism to change an application force of the applicator tool.

20. The method of 17, wherein the preformed sheet has a body portion and two spaced apart tail portions extending longitudinally from the body portion and wherein the preformed adhesive sheet has a variable elongation along its length when tensioned at constant force.

21. The method of claim 20, wherein the tail portions are wrapped around the cable connection simultaneously.

22-24. (canceled)
